(19) United States
(12) Patent Application Publication
(10) Pub. No.: US 2023/0100064 A1
(43) Pub. Date: Mar. 30, 2023

(54) CARBON NANOTUBE DISPERSION

(71) Applicant: NISSAN CHEMICAL CORPORATION, Tokyo (JP)

(72) Inventors: Takuma NAGAHAMA, Funabashi-shi (JP); Mari YAJIMA, Funabashi-shi (JP); Yuta KEMMIZAKI, Funabashi-shi (JP)

(73) Assignee: NISSAN CHEMICAL CORPORATION, Tokyo (JP)

(21) Appl. No.: 17/802,648

(22) PCT Filed: Feb. 24, 2021
(86) PCT No.: PCT/JP2021/006730

§ 371 Date: Aug. 26, 2022

(30) Foreign Application Priority Data
Feb. 27, 2020 (JP) 2020-031998

(51) Int. Cl. C01B 32/174

(52) U.S. Cl. CPC C01B 32/174; B82Y 30/00

(57) ABSTRACT

This invention provides a carbon nanotube dispersion that contains carbon nanotubes, a dispersant, a solvent, and a polymer which has a partial structure represented by formula (P1) on a side chain.

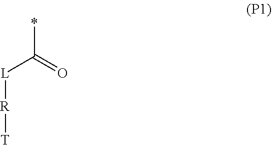

(In the formula, L represents —O— or —NH—, R represents an alkylene group having 1-20 carbon atoms, T represents a substituted or unsubstituted amino group, a nitrogen-containing heteroaryl group having 2-20 carbon atoms, or a nitrogen-containing aliphatic heterocyclic group having 2-20 carbon atoms, and * represents a bond.)

### TECHNICAL FIELD

The present invention relates to a carbon nanotube dispersion.

### BACKGROUND ART

Carbon nanotubes (hereinafter, sometimes abbreviated as CNTs) have been investigated as a potential material for nanotechnology with respect to the possibility of applications in a wide range of fields. Methods for application of CNTs are broadly classified into methods in which a single CNT itself is used as a transistor, a microscopic probe, or the like, and methods in which a multitude of CNTs are used collectively as a bulk such as an electron emission electrode, a fuel cell electrode, or a conductive composite dispersing CNTs.

In a case where a single CNT is used, for example, a method is used in which the CNT is added to a solvent and irradiated with an ultrasonic wave and then only the CNT dispersed individually is collected by electrophoresis or the like. In the case of a conductive composite used in the form of a bulk, CNTs are to be well dispersed in a polymer or the like serving as a matrix material. However, CNTs have a problem in that they are generally difficult to disperse. Ordinary composites are used with CNTs incompletely dispersed. Thus, it cannot be said that the performance of the CNTs is sufficiently exhibited. Furthermore, this problem leads to a difficulty in various applications of CNTs. To avoid this, various methods have been studied for improving dispersibility of CNTs by surface reforming, surface chemical modification, or the like.

As such a method of dispersing CNTs, there has been proposed a method of depositing, on the CNT surface, poly((m-phenylenevinylene)-co-(dioctoxy-p-phenylenevinylene)) having a coil-shaped structure (see, for example, Patent Document 1). In this method, CNTs can be discretely dispersed in an organic solvent, and the state of a single CNT deposited with a polymer is shown. Nevertheless, after once dispersed to some extent, CNTs are aggregated and collected as a sediment, and thus this method cannot be used for long term storage in a state where CNTs are dispersed.

### PRIOR ART DOCUMENTS

### Patent Documents

Patent Document 1: JP-A 2000-44216

### SUMMARY OF INVENTION

### Technical Problem

The present invention has been made in view of such circumstances, and an object of the present invention is to provide a carbon nanotube dispersion that can maintain a good dispersion state of a CNT in a medium such as water or a hydrophilic solvent and can stably disperse the CNT.

### Solution to Problem

As a result of intensive studies to achieve the above object, the present inventors have found that a polymer having a pendant chain having a specific partial structure can improve the dispersibility of a CNT in a dispersion containing the CNT, a dispersant, and a solvent, and can effectively suppress aggregation of the CNT, and thus the present invention has been completed.

That is, the present invention provides the following carbon nanotube dispersion.

1. A carbon nanotube dispersion including a carbon nanotube, a dispersant, a solvent, and a polymer having a pendant chain having a partial structure of formula (P1) described below:

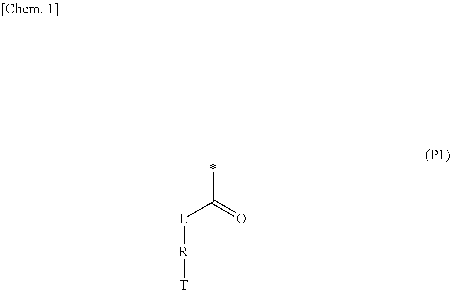

wherein L represents —O— or —NH—, R represents an alkylene group having 1 to 20 carbon atoms, T represents a substituted or unsubstituted amino group, a nitrogen-containing heteroaryl group having 2 to 20 carbon atoms, or a nitrogen-containing aliphatic heterocyclic group having 2 to 20 carbon atoms, and * represents a bonding site.
2. The carbon nanotube dispersion of 1 above, wherein the partial structure of formula (P1) has any one of formulas (P1-1) to (P1-3) described below:

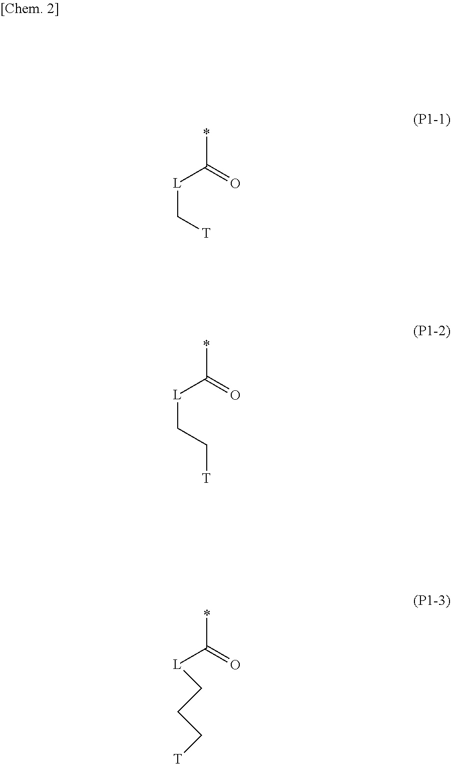

wherein L, T, and * are as described above.
3. The carbon nanotube dispersion of 2 above, wherein the partial structure of formula (P1) has any one of formulas (P2-1) to (P2-3) described below:

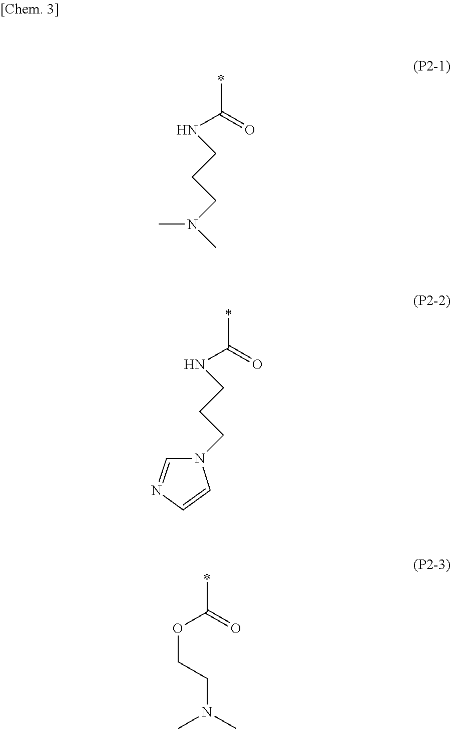

wherein * is as described above.
4. The carbon nanotube dispersion of 1 above, wherein the polymer includes repeating units of formula (C1-1) or (C1-2) described below:

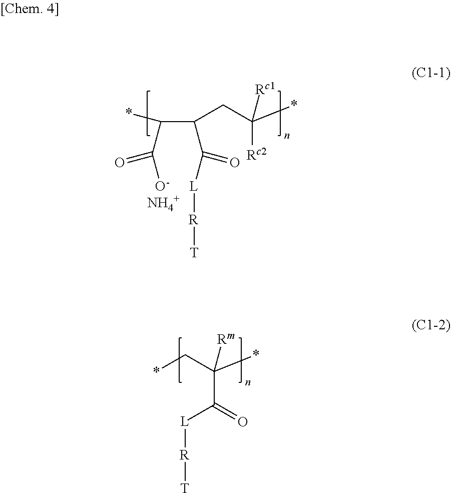

wherein R^{c1} and R^{c2} each independently represent a hydrogen atom or an alkyl group having 1 to 20 carbon atoms, R^{m} represents a hydrogen atom or a methyl group, n represents a natural number, and L, R, T, and * are as described above.
5. The carbon nanotube dispersion of any one of 1 to 4 above, wherein the solvent includes one or more selected from the group consisting of water and hydrophilic solvents.
6. The carbon nanotube dispersion of any one of 1 to 5 above, wherein the dispersant includes a pendant oxazoline group-containing polymer or a triarylamine-based highly branched polymer.
7. The carbon nanotube dispersion of any one of 1 to 6 above, further including a crosslinking agent.

### Advantageous Effects of Invention

According to the present invention, it is possible to provide a carbon nanotube dispersion that can maintain a good dispersion state of a CNT in a medium such as water or a hydrophilic solvent and can stably disperse the CNT.

Furthermore, in a dispersion including a CNT, a dispersant, and a solvent, aggregation of the CNT is suppressed by a simple method of adding a polymer having a pendant chain having a specific partial structure, and a good dispersion state can be maintained, so that the dispersion can contribute to improvement in manufacturing efficiency.

### DESCRIPTION OF EMBODIMENTS

The carbon nanotube dispersion according to the present invention (hereinafter, simply referred to as dispersion) is characterized by including a CNT, a dispersant, a solvent, and a polymer having a pendant chain having a partial structure of formula (P1) described below (hereinafter, sometimes referred to as P1 polymer).

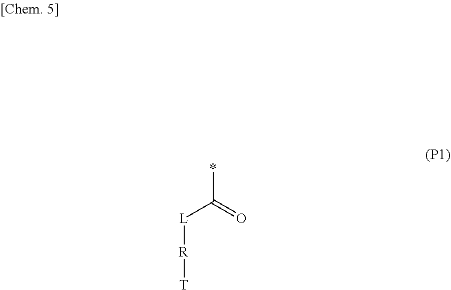

In the formula, L represents —O— or —NH—, R represents an alkylene group having 1 to 20 carbon atoms, and T represents a substituted or unsubstituted amino group, a nitrogen-containing heteroaryl group having 2 to 20 carbon atoms, or a nitrogen-containing aliphatic heterocyclic group having 2 to 20 carbon atoms. * represents a bonding site.

The alkylene group having 1 to 20 carbon atoms may be linear, branched, or cyclic, and examples of the alkylene group include a methylene group, an ethylene group, a propylene group, a trimethylene group, a tetramethylene group, a pentylene group, a hexylene group, a heptylene group, an octylene group, a nonylene group, a decylene group, an undecylene group, a dodecylene group, a tridecylene group, a tetradecylene group, a pentadecylene group, a hexadecylene group, a heptadecylene group, an octadecylene group, a nonadecylene group, and an eicosanylene group. In the present invention, an alkylene group having 1 to 10 carbon atoms is preferable, an alkylene group having 1 to 8 carbon atoms is more preferable, and an alkylene group having 1 to 3 carbon atoms is still more preferable.

The substituted or unsubstituted amino group is preferably a group represented by the following (A1).

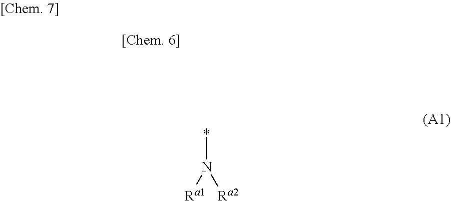

(In the formula, R^{a1} and R^{a2} each independently represent a hydrogen atom, an alkyl group having 1 to 20 carbon atoms, or a phenyl group. * is as described above.)

The alkyl group having 1 to 20 carbon atoms may be linear, branched, or cyclic, and examples of the alkyl group include linear or branched alkyl groups having 1 to 20 carbon atoms such as a methyl group, an ethyl group, an n-propyl group, an isopropyl group, an n-butyl group, an isobutyl group, an s-butyl group, a t-butyl group, an n-pentyl group, an n-hexyl group, an n-heptyl group, an n-octyl group, an n-nonyl group, and an n-decyl group and cyclic alkyl groups having 3 to 20 carbon atoms such as a cyclopropyl group, a cyclobutyl group, a cyclopentyl group, a cyclohexyl group, a cycloheptyl group, a cyclooctyl group, a cyclononyl group, a cyclodecyl group, a bicyclobutyl group, a bicyclopentyl group, a bicyclohexyl group, a bicycloheptyl group, a bicyclooctyl group, a bicyclononyl group, and a bicyclodecyl group.

R^{a1} and R^{a2} are preferably a hydrogen atom, an alkyl group having 1 to 10 carbon atoms, or a phenyl group, more preferably a hydrogen atom, an alkyl group having 1 to 5 carbon atoms, or a phenyl group, and still more preferably a methyl group. R^{a1} and R^{a2} may be the same as or different from each other, but are more preferably the same group.

Examples of the nitrogen-containing heteroaryl group having 2 to 20 carbon atoms include a 1-imidazolyl group, a 2-imidazolyl group, a 4-imidazolyl group, a 1-pyridyl group, a 2-pyridyl group, a 3-pyridyl group, a 4-pyridyl group, a pyrazine-1-yl group, a pyrazine-2-yl group, a pyrimidine-1-yl group, a pyrimidine-2-yl group, a pyrimidine-4-yl group, a pyrimidine-5-yl group, a pyridazine-1-yl group, a pyridazine-3-yl group, a pyridazine-4-yl group, a pyridazine-5-yl group, a 1,2,3-triazine-4-yl group, a 1,2,3-triazine-5-yl group, a 1,2,4-triazine-3-yl group, a 1,2,4-triazine-5-yl group, a 1,2,4-triazine-6-yl group, a 1,3,5-triazine-2-yl group, a 1,2,4,5-tetrazine-3-yl group, a 1,2,3,4-tetrazine-5-yl group, a quinoline-1-yl group, a quinoline-2-yl group, a quinoline-3-yl group, a quinoline-4-yl group, a quinoline-5-yl group, a quinoline-6-yl group, a quinoline-7-yl group, a quinoline-8-yl group, an isoquinoline-1-yl group, an isoquinoline-2-yl group, an isoquinoline-3-yl group, an isoquinoline-4-yl group, an isoquinoline-5-yl group, an isoquinoline-6-yl group, an isoquinoline-7-yl group, an isoquinoline-8-yl group, a quinoxaline-1-yl group, a quinoxaline-2-yl group, a quinoxaline-5-yl group, a quinoxaline-6-yl group, a quinazoline-1-yl group, a quinazoline-2-yl group, a quinazoline-3-yl group, a quinazoline-4-yl group, a quinazoline-5-yl group, a quinazoline-6-yl group, a quinazoline-7-yl group, a quinazoline-8-yl group, a cinnoline-1-yl group, a cinnoline-2-yl group, a cinnoline-3-yl group, a cinnoline-4-yl group, a cinnoline-5-yl group, a cinnoline-6-yl group, a cinnoline-7-yl group, and a cinnoline-8-yl group.

Examples of the nitrogen-containing aliphatic heterocyclic group having 2 to 20 carbon atoms include groups having an aziridine ring, groups having an azetidine ring, groups having a pyrrolidine ring, groups having a piperidine ring, groups having a hexamethyleneimine ring, groups having an imidazolidine ring, groups having a piperazine ring, and groups having a pyrazolidine ring. Specific examples of the nitrogen-containing aliphatic heterocyclic group include an aziridine-1-yl group, an aziridine-2-yl group, an azetidine-1-yl group, an azetidine-2-yl group, an azetidine-3-yl group, a pyrrolidine-1-yl group, a pyrrolidine-2-yl group, a pyrrolidine-3-yl group, a piperidine-1-yl group, a piperidine-2-yl group, a piperidine-3-yl group, a piperidine-4-yl group, an azepane-1-yl group, an azepane-2-yl group, an azepane-3-yl group, an azepane-4-yl group, an imidazolidine-1-yl group, an imidazolidine-2-yl group, an imidazolidine-4-yl group, a piperazine-1-yl group, a piperazine-2-yl group, a pyrazolidine-1-yl group, a pyrazolidine-3-yl group, a pyrazolidine-4-yl group, and a pyrazolidine-5-yl group.

Preferred aspects of the partial structure of formula (P1) include, but are not limited to, partial structures having formulas (P1-1) to (P1-3) described below.

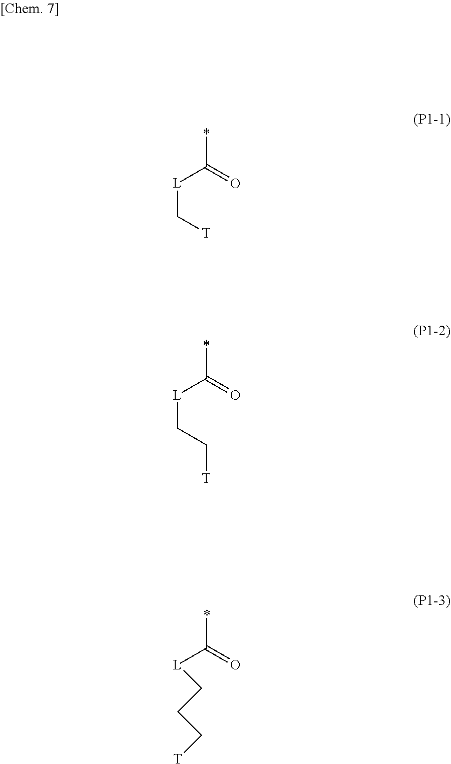

(In the formulas, L, T, and * are as described above.)

Specific examples of the partial structure of formula (P1) include, but are not limited to, partial structures having formulas (P2-1) to (P2-3) described below.

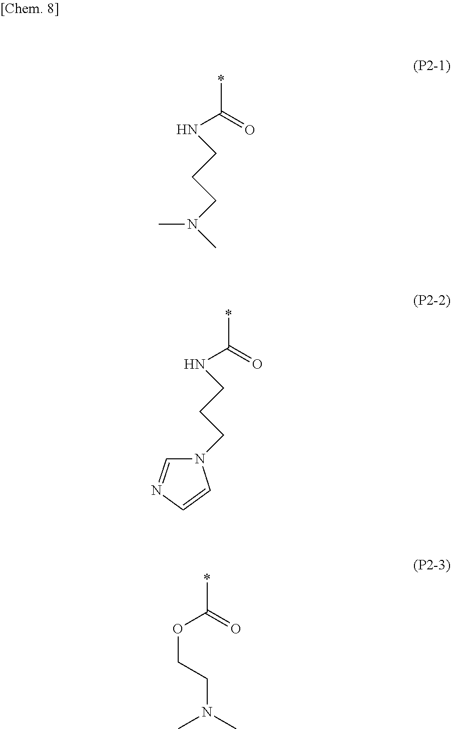

(In the formulas, * is as described above.)

The partial structure of (P1) may be directly bonded to the main chain of the polymer or bonded via a spacer group such as an alkylene group, but is preferably directly bonded to the main chain of the polymer.

Examples of the aspect of the P1 polymer include, but are not limited to, polymers including repeating units of formula (C1-1) or (C1-2) described below.

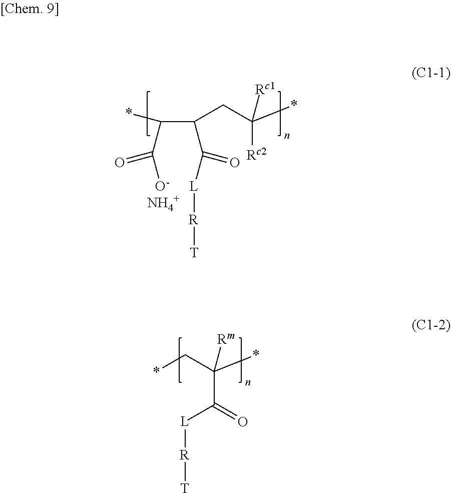

(In the formulas, R^{c1} and R^{c2} each independently represent a hydrogen atom or an alkyl group having 1 to 20 carbon atoms, R^{m} represents a hydrogen atom or a methyl group, and n represents a natural number. L, R, T, and * are as described above.)

Examples of the alkyl group having 1 to 20 carbon atoms include the alkyl groups described above as examples of R^{c1} and R^{c2}. Among these alkyl groups, R^{c1} and R^{c2} are preferably a hydrogen atom or an alkyl group having 1 to 10 carbon atoms, more preferably a hydrogen atom or an alkyl group having 1 to 5 carbon atoms, and still more preferably a methyl group. R^{c1} and R^{c2} may be the same as or different from each other, but are more preferably the same group.

Examples of the preferred aspect of the P1 polymer include, but are not limited to, polymers including repeating units of any of formulas (C2-1) to (C2-6) described below.

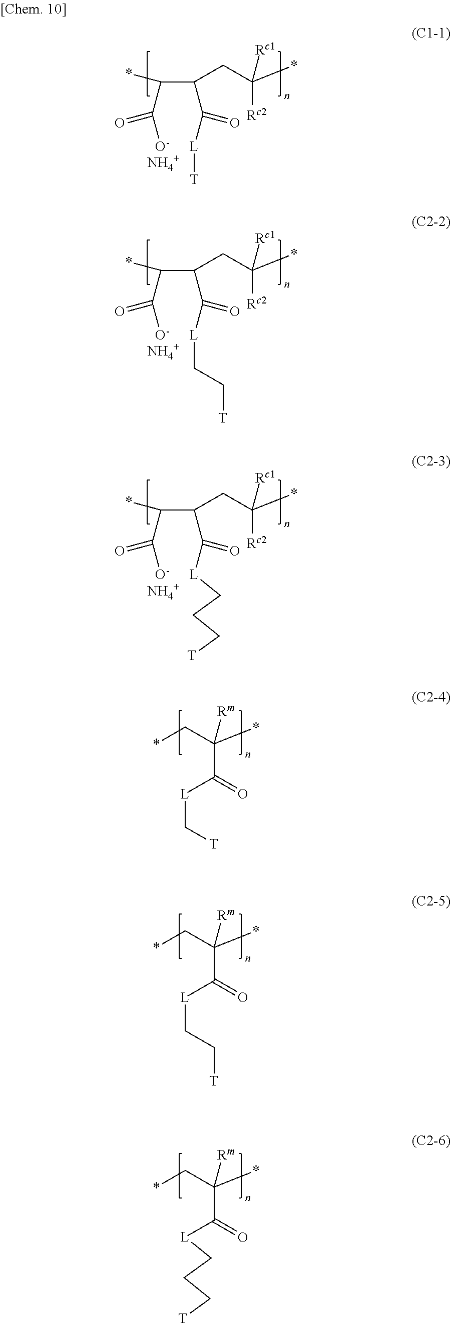

(In the formulas, L, T, R^{m}, n, and * are as described above.)

Specific examples of the P1 polymer include, but are not limited to, polymers including repeating units of any of formulas (C3-1) to (C3-3) described below.

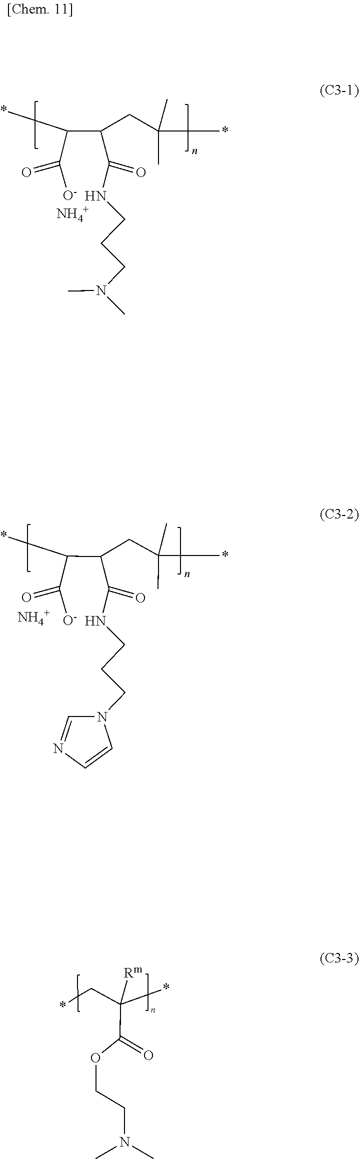

(In the formulas, R^{m}, n, and * are as described above.)

The average molecular weight of the P1 polymer is not particularly limited, but the weight average molecular weight (Mw) is preferably 1,000 to 2,000,000, and more preferably 2,000 to 1,000,000. The weight average molecular weight is a sodium polystyrene sulfonate-equivalent value obtained by gel permeation chromatography.

In the present invention, the P1 polymer preferably includes 10 to 100 mol %, more preferably 30 to 100 mol %, and still more preferably 50 to 100 mol % of the pendant chain of formula (P1) per all the repeating units from the viewpoint of improving the dispersibility of the CNT and the effect of suppressing aggregation of the CNT.

In the present invention, the P1 polymer may include, as repeating units other than the repeating units of formula (P1), repeating units to impart another function as long as an effect of the present invention is not impaired. Examples of such repeating units include repeating units having a crosslinking reactive group that causes a crosslinking reaction with a dispersant, and preferably include repeating units of the following formula (P3).

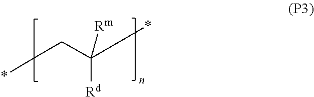

(In the formula, R^{d} represents a crosslinking reactive group. R^{m}, n, and * are as described above.)

Examples of R^{d} include a carboxy group, an aromatic thiol group, and a phenol group, and a carboxy group is preferable.

In the case of the P1 polymer including the repeating units of formula (P3), the content of the repeating units is preferably 10 to 70 mol %, more preferably 20 to 70 mol %, and still more preferably 30 to 70 mol % per all the repeating units.

In the polymer including the repeating units of formula (C1-1), examples of the repeating units other than the repeating units of formula (P1) include repeating units of the following formula (D1). The polymer may partially include repeating units of formula (C1-1′) described below as an unreacted site of a copolymer of isobutylene and maleic anhydride as raw materials of the polymer. In the polymer including the repeating units of formula (C1-2), examples of other repeating units include repeating units of the following formula (D2).

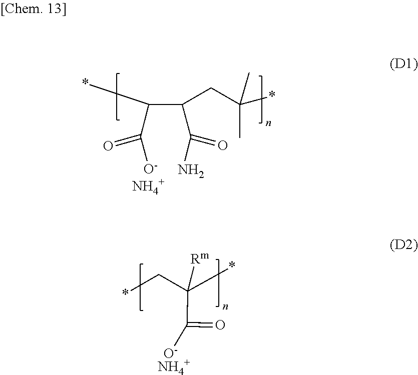

(In the formulas, n and * are as described above.)

The amount of the P1 polymer to be added depends on the solvent to be used, the substrate to be used, the required viscosity, the required film shape, and the like, and is preferably 10 to 1,000 parts by weight, more preferably 30 to 800 parts by weight, and still more preferably 40 to 500 parts by weight per 100 parts by weight of the CNT described below. By setting the amount of the P1 polymer to be added within the above range, the dispersibility of the CNT and the effect of suppressing aggregation of the CNT can be improved.

The P1 polymer can be obtained by a method of polymerizing a monomer obtained by reacting a compound of the following formula (Q1) with a compound having a carboxy group or an acid anhydride group (monomer raw material), or can be obtained by reacting a compound of the following formula (Q1) with a polymer having a pendant chain having a carboxy group or an acid anhydride group.

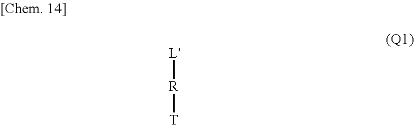

(In the formula, L′ represents an amino group or a hydroxy group. R and T are as described above.)

Preferred aspects of the compound of formula (Q1) include, but are not limited to, compounds having formulas (Q1-1) to (Q1-3) described below.

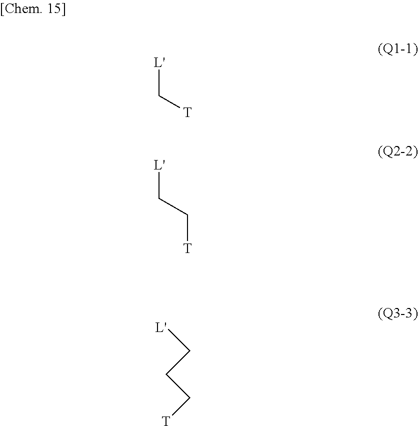

(In the formulas, L′ and T are as described above.)

Specific examples of the compound of formula (Q1) include 1-(3-aminopropyl)imidazole, 1-(3-hydroxypropyl)imidazole, N,N-dimethyl-1,3-propanediamine, and N,N-dimethylethanolamine.

Examples of the monomer raw material include maleic anhydride and (meth)acrylic acid.

Examples of the polymer having a pendant chain having a carboxy group or an acid anhydride group include a polymer of maleic anhydride, copolymers of an alkene having 2 to 10 carbon atoms such as isobutylene and maleic anhydride, and polymers of (meth)acrylic acid. In the present invention, a copolymer of isobutylene and maleic anhydride of the following formula (C1-1′) and a polymer of (meth)acrylic acid of the following formula (C1-2′) are preferable.

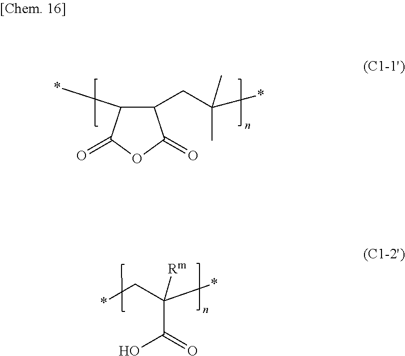

(In the formulas, R^{c1}, R^{c2}, R^{m}, n, and * are as described above.)

In the case of synthesizing a polymer including repeating units of formula (C3-1) as the P1 polymer, a method shown in the following scheme 1 can be used.

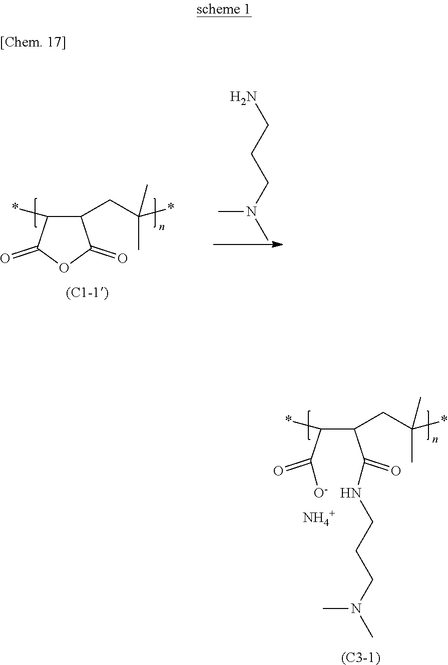

(In the formulas, n and * are as described above.)

In the scheme 1, a copolymer of isobutylene and maleic anhydride (C1-1′) is reacted with N,N-dimethyl-1,3-propanediamine, then the resulting reaction solution is stirred in the presence of ammonia for a predetermined time, and thus a polymer including repeating units of formula (C3-1) can be synthesized. As the copolymer of isobutylene and maleic anhydride (C1-1′), a commercially available product can be used, and examples of the product include the ISOBAM series (manufactured by Kuraray Co., Ltd.: trade name).

The solvent used in the above reaction is not particularly limited as long as it can disperse or dissolve a raw material to be used. Examples of such a solvent include dimethyl sulfoxide, N,N-dimethylformamide, N,N-dimethylacetamide, N-methyl-2-pyrrolidone (NMP), hexamethylphosphoric triamide, acetonitrile, acetone, alcohols (such as methanol, ethanol, 1-propanol, and 2-propanol), glycols (such as ethylene glycol and triethylene glycol), cellosolves (such as ethyl cellosolve and methyl cellosolve), polyhydric alcohols (such as glycerin and pentaerythritol), tetrahydrofuran, toluene, ethyl acetate, butyl acetate, benzene, toluene, xylene, pentane, hexane, heptane, chlorobenzene, dichlorobenzene, trichlorobenzene, hexadecane, benzyl alcohol, and oleylamine. Among them, N,N-dimethylformamide, N,N-dimethylacetamide, and N-methyl-2-pyrrolidone are preferable from the viewpoints of reaction temperature and reaction concentration. These solvents are to be appropriately selected according to the raw material to be used. The solvents may be used singly or in combination of two or more kinds thereof.

In the above reaction, the polymer (C1-1′) and N,N-dimethyl-1,3-propanediamine are preferably compounded in an amount to give a compounding ratio such that all of the acid anhydride groups in the polymer (C1-1′) can react with N,N-dimethyl-1,3-propanediamine, and the amount of N,N-dimethyl-1,3-propanediamine is preferably 1 to 3 mol, and more preferably 1 to 2 mol per 1 mol of the repeating units of the polymer (C1-1′).

The reaction temperature of the above reaction is usually 40 to 200° C. The reaction time is variously selected according to the reaction temperature, and is usually about 30 minutes to 50 hours.

The reaction solution of the obtained polymer may be used as it is, or may be diluted or concentrated for use, or the polymer may be isolated with an appropriate means and then dissolved in an appropriate solvent for use. Examples of the solvent include the solvents described above.

In the case of synthesizing a polymer including repeating units of formula (C3-3) as the above-described polymer, a method shown in the following scheme 2 can be used.

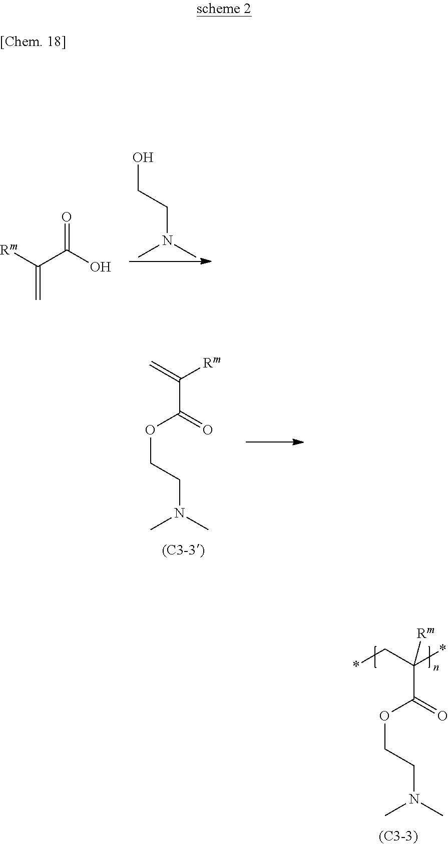

(In the formulas, R^{m}, n, and * are as described above.)

In the scheme 2, first, (meth)acrylic acid and N,N-dimethylethanolamine are esterified to synthesize a monomer (C3-3′) (first stage). Next, the obtained monomer (C3-3′) is polymerized in a solution (second stage), and thus a polymer including repeating units of formula (C3-3) can be synthesized. In a case where a commercially available product can be used as the monomer (C3-3′), the process may be performed from the second stage using the commercially available product as it is.

The solvent used in the reaction in the first stage is not particularly limited as long as it can disperse or dissolve a raw material to be used. Examples of such a solvent include the same solvents as those listed in the scheme 1, and the solvents are to be appropriately selected according to the raw material to be used. The solvents may be used singly or in combination of two or more kinds thereof.

In the above reaction, an acid or a base can be used as a catalyst. Specific examples thereof include inorganic acids such as hydrochloric acid, sulfuric acid, nitric acid, and phosphoric acid, organic carboxylic acids such as acetic acid, propionic acid, phthalic acid, and benzoic acid, organic sulfonic acids such as methylsulfonic acid, benzenesulfonic acid, p-toluenesulfonic acid, and trifluoromethanesulfonic acid, hydroxides of an alkali metal or alkaline earth metal such as sodium hydroxide, potassium hydroxide, and magnesium hydroxide, carbonates and hydrogen carbonates of an alkali metal or alkaline earth metal such as sodium hydrogen carbonate, potassium carbonate, and calcium hydrogen carbonate.

In the second stage, the monomer (C3-3′) obtained in the first stage is polymerized in a solvent. The polymerization method is not particularly limited, and can be appropriately selected from polymerization methods usually used in polymerization of an acrylic polymer. Examples of the polymerization method include a solution polymerization method, an emulsion polymerization method, and a suspension polymerization method. In the polymerization, an initiator may be used. As the initiator, a commercially available product can be used, and examples of the product include AIBN, VE-073, V-70, V-65, V-601, V-59, V-40, Vm-110, VA-044, V-046B, V-50, VA-057, VA-061, VA-086, and V-501 (all manufactured by FUJIFILM Wako Pure Chemical Corporation).

The reaction solution of the obtained polymer may be used as it is, or may be diluted or concentrated for use, or the polymer may be isolated with an appropriate means and then dissolved in an appropriate solvent for use. Examples of the solvent include the solvents described above.

CNTs are generally produced with an arc discharge method, a chemical vapor deposition method (CVD method), a laser ablation method, or the like, and the CNT used in the present invention may be obtained by any of these methods. CNTs are categorized as single-walled CNTs consisting of a single cylindrically rolled carbon film (graphene sheet) (abbreviated below as SWCNTs), double-walled CNTs consisting of two concentrically rolled graphene sheets (abbreviated below as DWCNTs), and multi-walled CNTs consisting of a plurality of concentrically rolled graphene sheets (MWCNTs). In the present invention, SWCNTs, DWCNTs, or MWCNTs may be used alone, or a plurality of these types of CNTs may be used m combination.

When the above methods are used to produce SWCNTs, DWCNTs, or MWCNTs, a catalyst metal such as nickel, iron, cobalt, or yttrium may remain in the product, and therefore purification to remove the impurity is sometimes necessary. For the removal of the impurity, acid treatment with nitric acid, sulfuric acid, or the like and ultrasonic treatment are effective. However, in the acid treatment with nitric acid, sulfuric acid, or the like, the π-conjugated system making up the CNTs may be destroyed to impair the properties inherent to the CNTs, so that it is desirable to purify and use the CNTs under suitable conditions.

Specific examples of the CNTs that may be used in the present invention include CNTs synthesized with the super growth method (manufactured by the New Energy and Industrial Technology Development Organization in the National Research and Development Agency), eDIPS-CNTs (manufactured by the New Energy and Industrial Technology Development Organization in the National Research and Development Agency), the SWNT series (manufactured by MEIJO NANO CARBON Co., Ltd.: trade name), the VGCF series (manufactured by Showa Denko K.K.: trade name), the FloTube series (manufactured by CNano Technology: trade name), AMC (manufactured by Ube Industries, Ltd.: trade name), the NANOCYL NC7000 series (manufactured by Nanocyl S.A.: trade name), Baytubes (manufactured by Bayer: trade name), GRAPHISTRENGTH (manufactured by Arkema S.A.: trade name), MWNT7 (manufactured by Hodogaya Chemical Co., Ltd.: trade name), Hyperion CNT (manufactured by Hypeprion Catalysis International: trade name), the TC series (manufactured by TODA KOGYO CORP.: trade name), and the FloTube series (manufactured by Jiangsu Cnano Technology Ltd.: trade name).

The dispersant can be appropriately selected from those conventionally used as dispersants for conductive carbon materials such as CNTs, and examples thereof include carboxymethyl cellulose (CMC), polyvinyl pyrrolidone (PVP), acrylic resin emulsions, water-soluble acrylic polymers, styrene emulsions, silicon emulsions, acrylic silicon emulsions, fluororesin emulsions, EVA emulsions, vinyl acetate emulsions, vinyl chloride emulsions, urethane resin emulsions, a triarylamine-based highly branched polymer described in WO 2014/042080, and a pendant oxazoline group-containing polymer described in WO 2015/029949. In the present invention, it is preferable to use a dispersant including a pendant oxazoline group-containing polymer described in WO 2015/029949 or a dispersant including a triarylamine-based highly branched polymer described in WO 2014/042080.

The pendant oxazoline group-containing polymer (hereinafter, referred to as oxazoline polymer) is preferably a pendant oxazoline group-containing vinyl-based polymer that is obtained by radical polymerization of an oxazoline monomer of formula (1) having a polymerizable carbon-carbon double bond-containing group at the second position and has repeating units that are bonded at the second position of the oxazoline ring to the polymer main chain or to spacer groups.

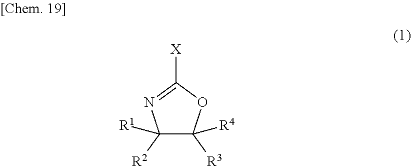

X represents a polymerizable carbon-carbon double bond-containing group, and R¹ to R⁴ each independently represent a hydrogen atom, a halogen atom, an alkyl group having 1 to 5 carbon atoms, an aryl group having 6 to 20 carbon atoms, or an aralkyl group having 7 to 20 carbon atoms.

The polymerizable carbon-carbon double bond-containing group of the oxazoline monomer is not particularly limited as long as the group contains a polymerizable carbon-carbon double bond, but a chain hydrocarbon group containing a polymerizable carbon-carbon double bond is preferable. For example, alkenyl groups having 2 to 8 carbon atoms such as a vinyl group, an allyl group, and an isopropenyl group are preferable. Examples of the halogen atom include a fluorine atom, a chlorine atom, a bromine atom, and an iodine atom. The alkyl group having 1 to 5 carbon atoms may be linear, branched, or cyclic, and examples of the alkyl group include a methyl group, an ethyl group, an n-propyl group, an isopropyl group, an n-butyl group, a sec-butyl group, a tert-butyl group, an n-pentyl group, and a cyclohexyl group. Examples of the aryl group having 6 to 20 carbon atoms include a phenyl group, a xylyl group, a tolyl group, a biphenyl group, and a naphthyl group. Examples of the aralkyl group having 7 to 20 carbon atoms include a benzyl group, a phenylethyl group, and a phenylcyclohexyl group.

Examples of the oxazoline monomer of formula (1) having a polymerizable carbon-carbon double bond-containing group at the second position include 2-vinyl-2-oxazoline, 2-vinyl-4-methyl-2-oxazoline, 2-vinyl-4-ethyl-2-oxazoline, 2-vinyl-4-propyl-2-oxazoline, 2-vinyl-4-butyl-2-oxazoline, 2-vinyl-5-methyl-2-oxazoline, 2-vinyl-5-ethyl-2-oxazoline, 2-vinyl-5-propyl-2-oxazoline, 2-vinyl-5-butyl-2-oxazoline, 2-isopropenyl-2-oxazoline, 2-isopropenyl-4-methyl-2-oxazoline, 2-isopropenyl-4-ethyl-2-oxazoline, 2-isopropenyl-4-propyl-2-oxazoline, 2-isopropenyl-4-butyl-2-oxazoline, 2-isopropenyl-5-methyl-2-oxazoline, 2-isopropenyl-5-ethyl-2-oxazoline, 2-isopropenyl-5-propyl-2-oxazoline, and 2-isopropenyl-5-butyl-2-oxazoline, and 2-isopropenyl-2-oxazoline is preferable from the viewpoint of availability and the like.

In consideration that an aqueous solvent is used for preparing a dispersion, the oxazoline polymer is also preferably water-soluble. Such a water-soluble oxazoline polymer may be a homopolymer of the oxazoline monomer of formula (1), but in order to further enhance the solubility in water, the water-soluble oxazoline polymer is preferably obtained by radical polymerization of at least two monomers including the oxazoline monomer and a (meth)acrylic acid ester-based monomer having a hydrophilic functional group.

Examples of the (meth)acrylic monomer having a hydrophilic functional group include (meth)acrylic acid, 2-hydroxyethyl acrylate, methoxy polyethylene glycol acrylate, monoesters of acrylic acid with polyethylene glycol, 2-aminoethyl acrylate and its salts, 2-hydroxyethyl methacrylate, methoxy polyethylene glycol methacrylate, monoesters of methacrylic acid with polyethylene glycol, 2-aminoethyl methacrylate and its salts, sodium (meth)acrylate, ammonium (meth)acrylate, (meth)acrylonitrile, (meth)acrylamide, N-methylol (meth)acrylamide, N-(2-hydroxyethyl) (meth)acrylamide, and sodium styrenesulfonate. They may be used singly or in combination of two or more kinds thereof. Among them, methoxy polyethylene glycol (meth)acrylate and monoesters of (meth)acrylic acid with polyethylene glycol are suitable.

In addition to the oxazoline monomer and the (meth)acrylic monomer having a hydrophilic functional group, other monomers can be used in combination as long as the CNT-dispersing ability of the oxazoline polymer is not adversely affected. Examples of such other monomers include (meth)acrylic acid ester monomers such as methyl (meth)acrylate, ethyl (meth)acrylate, butyl (meth)acrylate, 2-ethylhexyl (meth)acrylate, stearyl (meth)acrylate, perfluoroethyl (meth)acrylate, and phenyl (meth)acrylate, olefin-based monomers such as ethylene, propylene, butene, and pentene, haloolefin-based monomers such as vinyl chloride, vinylidene chloride, and vinyl fluoride, styrene-based monomers such as styrene and α-methylstyrene, vinyl carboxylate-based monomers such as vinyl acetate and vinyl propionate, and vinyl ether-based monomers such as methyl vinyl ether and ethyl vinyl ether. They may each be used singly or may be used in combination of two or more kinds thereof.

In the monomer components used for manufacturing the oxazoline polymer used in the present invention, the content of the oxazoline monomer is preferably 10 wt % or more, more preferably 20 wt % or more, and still more preferably 30 wt % or more from the viewpoint of further enhancing the CNT-dispersing ability of the resulting oxazoline polymer. The upper limit of the content of the oxazoline monomer in the monomer components is 100 wt %, and if the content is 100 wt %, a homopolymer of the oxazoline monomer is obtained.

Meanwhile, from the viewpoint of further enhancing the water solubility of the resulting oxazoline polymer, the content of the (meth)acrylic monomer having a hydrophilic functional group in the monomer components is preferably 10 wt % or more, more preferably 20 wt % or more, and still more preferably 30 wt % or more.

As described above, the content of other monomers in the monomer components is in a range in which the CNT-dispersing ability of the resulting oxazoline polymer is not affected, and the content depends on the kinds of monomers. Therefore, the content cannot be strictly specified, but is to be suitably set preferably in the range of 5 to 95 wt %, and more preferably 10 to 90 wt %.

The average molecular weight of the oxazoline polymer is not particularly limited, but the weight average molecular weight is preferably 1,000 to 2,000,000, and more preferably 2,000 to 1,000,000. The weight average molecular weight is a polystyrene-equivalent value obtained by gel permeation chromatography.

The oxazoline polymer that may be used in the present invention can be synthesized by a known radical polymerization of the above monomers, or can be acquired as a commercially available product. Examples of such a commercially available product include EPOCROS WS-300 (manufactured by NIPPON SHOKUBAI CO., LTD., solid content concentration: 10 wt %, aqueous solution), EPOCROS WS-700 (manufactured by NIPPON SHOKUBAI CO., LTD., solid content concentration: 25 wt %, aqueous solution), EPOCROS WS-500 (manufactured by NIPPON SHOKUBAI CO., LTD., solid content concentration: 39 wt %, water/1-methoxy-2-propanol solution), Poly(2-ethyl-2-oxazoline) (Aldrich), Poly(2-ethyl-2-oxazoline) (Alfa Aesar), and Poly(2-ethyl-2-oxazoline) (VWR International, LLC).

An oxazoline polymer that is commercially available in the form of a solution may be used as it is, or may be used after replacing the solvent with a target solvent.

Suitable use can be made of triarylamine-based highly branched polymers of formulas (2) and (3) described below obtained by condensation polymerization of a triarylamine with an aldehyde and/or a ketone under acidic conditions.

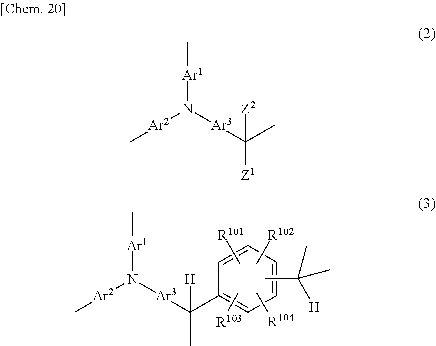

In the above-described formulas (2) and (3), Ar¹ to Ar³ each independently represent any of divalent organic groups of formulas (4) to (8), and a substituted or unsubstituted phenylene group of formula (4) is particularly preferable.

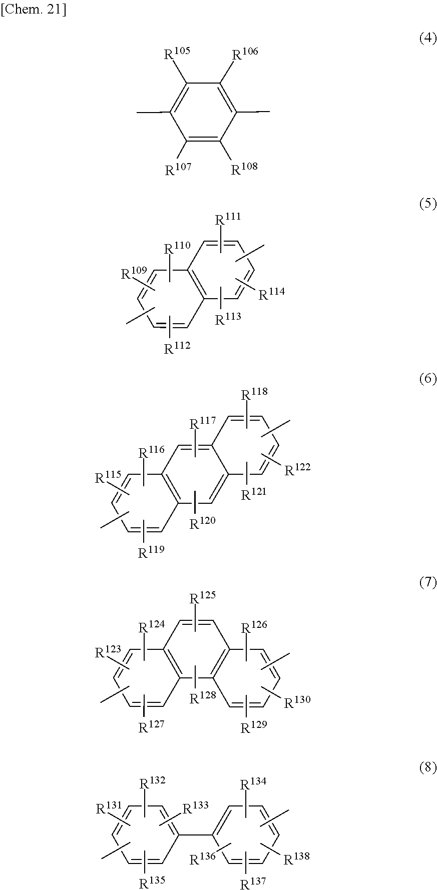

In formulas (2) and (3), Z¹ and Z² each independently represent a hydrogen atom, a linear or branched alkyl group having 1 to 5 carbon atoms, or any of monovalent organic groups of formulas (9) to (12) (provided that Z¹ and Z² do not represent the alkyl group at the same time).

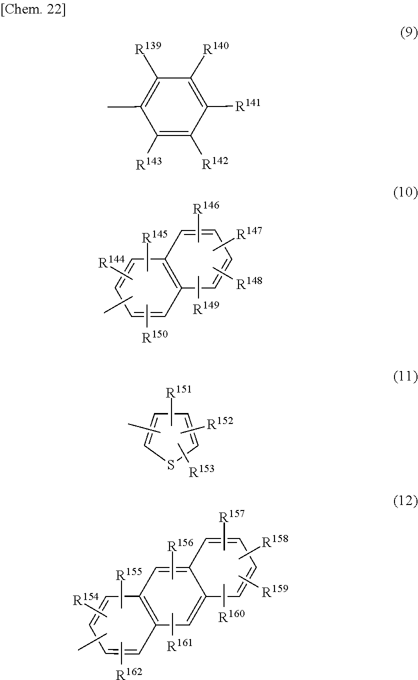

In the above-described formulas (3) to (8), R¹⁰¹ to R¹³⁸ each independently represent a hydrogen atom, a halogen atom, a linear or branched alkyl group having 1 to 5 carbon atoms, a linear or branched alkoxy group having 1 to 5 carbon atoms, a carboxyl group, a sulfo group, a phosphate group, a phosphonic acid group, or a salt thereof.

Examples of the halogen atom include a fluorine atom, a chlorine atom, a bromine atom, and an iodine atom.

Examples of the linear or branched alkyl group having 1 to 5 carbon atoms include a methyl group, an ethyl group, an n-propyl group, an isopropyl group, an n-butyl group, a sec-butyl group, a tert-butyl group, and an n-pentyl group.

Examples of the linear or branched alkoxy group having 1 to 5 carbon atoms include a methoxy group, an ethoxy group, an n-propoxy group, an isopropoxy group, an n-butoxy group, a sec-butoxy group, a tert-butoxy group, and an n-pentoxy group.

Examples of the salts of a carboxyl group, a sulfo group, a phosphate group, and a phosphonic acid group include salts of alkali metals such as sodium and potassium, salts of Group 2 metals such as magnesium and calcium, ammonium salts, salts of aliphatic amines such as propylamine, dimethylamine, triethylamine, and ethylenediamine, salts of alicyclic amines such as imidazoline, piperazine, and morpholine, salts of aromatic amines such as aniline and diphenylamine, and pyridinium salts.

In the above-described formulas (9) to (12), R¹³⁹ to R¹⁶² each independently represent a hydrogen atom, a halogen atom, a linear or branched alkyl group having 1 to 5 carbon atoms, a linear or branched haloalkyl group having 1 to 5 carbon atoms, a phenyl group, OR¹⁶³, COR¹⁶³, NR¹⁶³R¹⁶⁴, COOR¹⁶⁵ (wherein R¹⁶³ and R¹⁶⁴ each independently represent a hydrogen atom, a linear or branched alkyl group having 1 to 5 carbon atoms, a linear or branched haloalkyl group having 1 to 5 carbon atoms, or a phenyl group, and R¹⁶⁵ represents a linear or branched alkyl group having 1 to 5 carbon atoms, a linear or branched haloalkyl group having 1 to 5 carbon atoms, or a phenyl group), a carboxyl group, a sulfo group, a phosphate group, a phosphonic acid group, or a salt thereof.

Here, examples of the linear or branched haloalkyl group having 1 to 5 carbon atoms include a difluoromethyl group, a trifluoromethyl group, a bromodifluoromethyl group, a 2-chloroethyl group, a 2-bromoethyl group, a 1,1-difluoroethyl group, a 2,2,2-trifluoroethyl group, a 1,1,2,2-tetrafluoroethyl group, a 2-chloro-1,1,2-trifluoroethyl group, a pentafluoroethyl group, a 3-bromopropyl group, a 2,2,3,3-tetrafluoropropyl group, a 1,1,2,3,3,3-hexafluoropropyl group, a 1,1,1,3,3,3-hexafluoropropane-2-yl group, a 3-bromo-2-methylpropyl group, a 4-bromobutyl group, and a perfluoropentyl group.

Examples of the halogen atom and the linear or branched alkyl group having 1 to 5 carbon atoms include the same groups as those described above as examples in formulas (3) to (8).

Z¹ and Z² are each independently preferably a hydrogen atom, a 2- or 3-thienyl group, or a group of formula (9), and it is particularly preferable that one of Z¹ and Z² be a hydrogen atom and the other be a hydrogen atom, a 2- or 3-thienyl group, or a group of formula (9), and in particular, it is more preferable that R¹⁴¹ be a phenyl group or R¹⁴¹ be a methoxy group.

In a case where R¹⁴¹ is a phenyl group and the acidic group insertion method described below is used in which an acidic group is inserted after manufacturing a polymer, an acidic group may be inserted onto this phenyl group.

In particular in consideration of further improving the dispersibility of the CNT, the highly branched polymer preferably has at least one acidic group selected from a carboxyl group, a sulfo group, a phosphate group, a phosphonic acid group, and salts thereof in at least one aromatic ring in the repeating units of formula (2) or (3), and more preferably has a sulfo group or its salt.

Examples of the aldehyde compound used for manufacturing the highly branched polymer include saturated aliphatic aldehydes such as formaldehyde, paraformaldehyde, acetaldehyde, propylaldehyde, butyraldehyde, isobutyraldehyde, valeraldehyde, capronaldehyde, 2-methylbutyraldehyde, hexylaldehyde, undecylaldehyde, 7-methoxy-3,7-dimethyloctylaldehyde, cyclohexanecarboxyaldehyde, 3-methyl-2-butyraldehyde, glyoxal, malonaldehyde, succinaldehyde, glutaraldehyde, and adipinaldehyde, unsaturated aliphatic aldehydes such as acrolein and methacrolein, heterocyclic aldehydes such as furfural, pyridinealdehyde, and thiophenealdehyde, aromatic aldehydes such as benzaldehyde, tolylaldehyde, trifluoromethylbenzaldehyde, phenylbenzaldehyde, salicylaldehyde, anisaldehyde, acetoxybenzaldehyde, terephthalaldehyde, acetylbenzaldehyde, formylbenzoic acid, methyl formylbenzoate, aminobenzaldehyde, N,N-dimethylaminobenzaldehyde, N,N-diphenylaminobenzaldehyde, naphthylaldehyde, anthrylaldehyde, and phenanthrylaldehyde, and aralkyl aldehydes such as phenylacetaldehyde and 3-phenylpropionaldehyde. Among them, aromatic aldehydes are preferably used.

The ketone compound used for manufacturing the highly branched polymer is an alkyl aryl ketone or a diaryl ketone, and examples of the ketone include acetophenone, propiophenone, diphenyl ketone, phenyl naphthyl ketone, dinaphthyl ketone, phenyl tolyl ketone, and ditolyl ketone.

The highly branched polymer used in the present invention can be manufactured, for example, according to the method described in WO 2014/042080.

The average molecular weight of the highly branched polymer is not particularly limited, but the weight average molecular weight is preferably 1,000 to 2,000,000, and more preferably 2,000 to 1,000,000.

Specific examples of the highly branched polymer include, but are not limited to, those represented by the following formula.

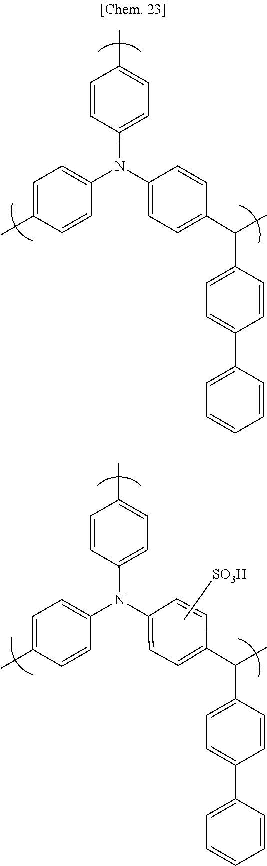

In the present invention, the CNT and the dispersant can be mixed at a ratio by weight of about 1,000:1 to 1:100.

The amount of the dispersant added is not particularly limited as long as the concentration of the dispersant is such that the CNT can be dispersed in the solvent, but is preferably 5 to 700 parts by weight, more preferably 10 to 500 parts by weight, and still more preferably 20 to 300 parts by weight per 100 parts by weight of the CNT.

As long as an effect of the present invention is not impaired, the dispersion of the present invention may include a crosslinking agent that causes a crosslinking reaction with the used dispersant, or may include a self-crosslinking agent. These crosslinking agents are preferably dissolved in a solvent to be used.

Examples of the crosslinking agent of the triarylamine-based highly branched polymer include melamine-based crosslinking agents, substituted urea-based crosslinking agents, and polymer-based crosslinking agents including a polymer of melamine or substituted urea. These crosslinking agents can be used singly, or in combination of two or more kinds thereof. A crosslinking agent having at least two crosslink-forming substituents is preferred, and examples of such a crosslinking agent include compounds such as CYMEL (registered trademark), methoxymethylated glycoluril, butoxymethylated glycoluril, methylolated glycoluril, methoxymethylated melamine, butoxymethylated melamine, methylolated melamine, methoxymethylated benzoguanamine, butoxymethylated benzoguanamine, methylolated benzoguanamine, methoxymethylated urea, butoxymethylated urea, methylolated urea, methoxymethylated thiourea, methoxymethylated thiourea, and methylolated thiourea, and condensates of these compounds.

The crosslinking agent of the oxazoline polymer is not particularly limited as long as the crosslinking agent is a compound having two or more functional groups that react with oxazoline groups, such as carboxyl, hydroxyl, thiol, amino, sulfinic acid, and epoxy groups, but a compound having two or more carboxyl groups is preferable. As the crosslinking agent, a compound can be used that has functional groups that generate, under heating during thin-film formation or in the presence of an acid catalyst, the functional groups described above to cause crosslinking reactions, and examples of such a compound include compounds having a sodium salt, a potassium salt, a lithium salt, an ammonium salt, or the like of carboxylic acid.

Specific examples of the compound that causes a crosslinking reaction with an oxazoline group include metal salts that exhibit crosslinking reactivity in the presence of an acid catalyst, including metal salts of synthetic polymers such as polyacrylic acid and copolymers thereof and metal salts of natural polymers such as carboxymethylcellulose and alginic acid, and include ammonium salts that exhibit crosslinking reactivity under heating, including ammonium salts of the above-described synthetic polymers and natural polymers. In particular, sodium polyacrylate, lithium polyacrylate, ammonium polyacrylate, carboxymethylcellulose sodium, carboxymethylcellulose lithium, carboxymethylcellulose ammonium, and the like, which exhibit crosslinking reactivity in the presence of an acid catalyst or under heating conditions, are preferable.

Such a compound that causes a crosslinking reaction with an oxazoline group can be acquired as a commercially available product. Examples of the commercially available product include sodium polyacrylate (manufactured by FUJIFILM Wako Pure Chemical Corporation, degree of polymerization: 2,700 to 7,500), carboxymethylcellulose sodium (manufactured by FUJIFILM Wako Pure Chemical Corporation), sodium alginate (manufactured by KANTO CHEMICAL CO., INC., Cica first grade), Aron A-30 (ammonium polyacrylate, manufactured by Toagosei Co., Ltd., solid content concentration: 32 wt %, aqueous solution), DN-800H (carboxymethylcellulose ammonium, manufactured by Daicel FineChem Ltd.) and ammonium alginate (manufactured by KIMICA Corporation).

Examples of the self-crosslinking agent include compounds having, on the same molecule, crosslinkable functional groups that react with one another, such as a hydroxyl group with an aldehyde group, epoxy group, vinyl group, isocyanate group, or alkoxy group, a carboxyl group with an aldehyde group, amino group, isocyanate group, or epoxy group, or an amino group with an isocyanate group or aldehyde group, and compounds having like crosslinkable functional groups that react with one another, such as hydroxyl groups (dehydration condensation), mercapto groups (disulfide bonding), ester groups (Claisen condensation), silanol groups (dehydration condensation), vinyl groups, or acrylic groups.

Specific examples of the self-crosslinking agent include self-crosslinking agents that exhibit crosslinking reactivity in the presence of an acid catalyst, such as polyfunctional acrylates, tetraalkoxysilanes, and block copolymers of a blocked isocyanate group-containing monomer and a monomer having at least one of a hydroxyl group, carboxylic acid, or an amino group.

Such a self-crosslinking agent can be acquired as a commercially available product. Examples of the commercially available product include polyfunctional acrylates such as A-9300 (ethoxylated isocyanuric acid triacrylate, manufactured by SHIN-NAKAMURA CHEMICAL Co., Ltd.), A-GLY-9E (Ethoxylated glycerine triacrylate (EU 9 mol), manufactured by SHIN-NAKAMURA CHEMICAL Co., Ltd.), and A-TMMT (pentaerythritol tetraacrylate, manufactured by SHIN-NAKAMURA CHEMICAL Co., Ltd.), tetraalkoxysilanes such as tetramethoxysilane (manufactured by Tokyo Chemical Industry Co., Ltd.) and tetraethoxysilane (manufactured by Toyoko Kagaku Co., Ltd.), and blocked isocyanate group-containing polymers such as the ELASTRON series E-37, H-3, H38, BAP, NEW BAP-15, C-52, F-29, W-11P, MF-9, and MF-25K (manufactured by DKS Co., Ltd.).

In the case of adding a crosslinking agent, the amount of the crosslinking agent depends on the solvent to be used, the substrate to be used, the required viscosity, the required film shape, and the like, and is preferably 5 to 1,000 parts by weight, more preferably 10 to 800 parts by weight, and still more preferably 20 to 500 parts by weight per 100 parts by weight of the CNT. Although these crosslinking agents may cause a crosslinking reaction by self-condensation, they cause a crosslinking reaction with the dispersant, and in a case where a crosslinkable substituent is present in the dispersant, the crosslinkable substituent promotes the crosslinking reaction.

The solvent used for preparing the dispersion of the present invention is not particularly limited, and examples of the solvent include water and hydrophilic solvents. Hydrophilic solvents are organic solvents that arbitrarily mix with water, and examples thereof include organic solvents including ethers such as tetrahydrofuran (THF), amides such as N,N-dimethylformamide (DMF), N,N-dimethylacetamide (DMAc), and N-methyl-2-pyrrolidone (NMP), ketones such as acetone, alcohols such as methanol, ethanol, n-propanol, and isopropanol, glycol ethers such as ethylene glycol monoethyl ether, ethylene glycol monobutyl ether, and propylene glycol monomethyl ether, and glycols such as ethylene glycol and propylene glycol. These solvents can be used singly or in combination of two of more kinds thereof. Particularly preferable solvents are water, NMP, DMF, THF, methanol, ethanol, n-propanol, isopropanol, n-butanol, and t-butanol from the viewpoint of increasing the proportion of the CNT discretely dispersed. From the viewpoint of improving the coatability, solvents preferably included are methanol, ethanol, n-propanol, isopropanol, n-butanol, t-butanol, and ethylene glycol monobutyl ether. From the viewpoint of lowering the cost, water is preferably included. These solvents can be used singly or in combination of two or more kinds thereof for the purpose of increasing the proportion of discrete dispersion, improving the coatability, and lowering the cost.

A polymer that serves as a matrix may be added to the dispersion of the present invention. Examples of the matrix polymer include thermoplastic resins including fluorine-based resins such as polyvinylidene fluoride (PVdF), polytetrafluoroethylene, tetrafluoroethylene-hexafluoropropylene copolymers, vinylidene fluoride-hexafluoropropylene copolymers [P(VDF-HFP)], and vinylidene fluoride-chlorotrifluoroethylene copolymers [P(VDF-CTFE)], polyolefin-based resins such as polyvinylpyrrolidone, ethylene-propylene-diene ternary copolymers, polyethylene (PE), polypropylene (PP), ethylene-vinyl acetate copolymers (EVA), and ethylene-ethyl acrylate copolymers (EEA), polystyrene-based resins such as polystyrene (PS), high-impact polystyrene (HIPS), acrylonitrile-styrene copolymers (AS), acrylonitrile-butadiene-styrene copolymers (ABS), methyl methacrylate-styrene copolymers (MS), and styrene-butadiene rubber, polycarbonate resins, vinyl chloride resins, polyamide resins, polyimide resins, (meth)acrylic resins such as sodium polyacrylate and polymethyl methacrylate (PMMA), polyester resins such as polyethylene terephthalate (PET), polybutylene terephthalate, polyethylene naphthalate, polybutylene naphthalate, polylactic acid (PLA), poly-3-hydroxybutyric acid, polycaprolactone, polybutylene succinate, and polyethylene succinate/adipate, polyphenylene ether resins, modified polyphenylene ether resins, polyacetal resins, polysulfone resins, polyphenylene sulfide resins, polyvinyl alcohol resins, polyglycolic acids, modified starches, cellulose acetate, carboxymethylcellulose, cellulose triacetate, chitin, chitosan, and lignin; electrically conductive polymers including polyaniline and emeraldine base as the semi-oxidized form of polyaniline, polythiophene, polypyrrole, polyphenylene vinylene, polyphenylene, and polyacetylene; and thermosetting resins and photo-curing resins including epoxy resins, urethane acrylate, phenolic resins, melamine resins, urea resins, and alkyd resins. Among them, polymers that are also water-soluble in the form of a matrix polymer are suitable because in the dispersion of the present invention, water is preferably used as the solvent. Examples of such polymers include sodium polyacrylate, carboxymethylcellulose sodium, water-soluble cellulose ether, sodium alginate, polyvinyl alcohol, polystyrene sulfonic acid, and polyethylene glycol, and polyacrylic acid, carboxymethylcellulose sodium, and the like are particularly suitable.

The matrix polymer can be acquired as a commercially available product. Examples of the commercially available product include sodium polyacrylate (manufactured by FUJIFILM Wako Pure Chemical Corporation, degree of polymerization: 2,700 to 7,500), carboxymethylcellulose sodium (manufactured by FUJIFILM Wako Pure Chemical Corporation), sodium alginate (manufactured by KANTO CHEMICAL CO., INC., Cica first grade), the METOLOSE SH series (hydroxypropylmethyl cellulose, manufactured by Shin-Etsu Chemical Co., Ltd.), the METOLOSE SE series (hydroxyethylmethyl cellulose, manufactured by Shin-Etsu Chemical Co., Ltd.), JC-25 (a fully saponified polyvinyl alcohol, manufactured by JAPAN VAM & POVAL CO., LTD.), JM-17 (an intermediately saponified polyvinyl alcohol, manufactured by JAPAN VAM & POVAL CO., LTD.), JP-03 (a partially saponified polyvinyl alcohol, manufactured by JAPAN VAM & POVAL CO., LTD.), and polystyrene sulfonic acid (manufactured by Aldrich, solid content concentration: 18 wt %, aqueous solution).

In the case of adding a matrix polymer, the amount of the matrix polymer added is not particularly limited, but is preferably about 0.0001 to 99 wt %, and more preferably about 0.001 to 90 wt % in the dispersion.

The method of preparing the dispersion of the present invention is not particularly limited, and a dispersion is to be prepared by mixing a CNT, a dispersant, a solvent, a P1 polymer, a matrix polymer used as necessary, and the like in any order. At this time, in a case where the P1 polymer has crosslinking reactive groups such as a carboxy group and an unintended crosslinking reaction may occur between the crosslinking reactive groups and the dispersant, a part or all of the crosslinking reactive groups may be neutralized with a base such as ammonia. Furthermore, the mixture is preferably subjected to dispersion treatment, and this treatment can increase the proportion of the CNT dispersed. Examples of the dispersion treatment include mechanical treatment including wet treatment using a ball mill, a bead mill, a jet mill, or the like and ultrasonic treatment using a bath-type or probe-type sonicator, and wet treatment using a jet mill and ultrasonic treatment are suitable.

The dispersion treatment may be performed for an optional time, but the time is preferably about 1 minute to 10 hours, and more preferably about 5 minutes to 5 hours. At this time, heat treatment may be performed as necessary.

In the case of using optional components such as a matrix polymer, the optional components may be added after preparing a mixture including a CNT, a dispersant, and a solvent.

In the present invention, the solid content concentration of the dispersion is not particularly limited, but is preferably 20 wt % or less, more preferably 15 wt % or less, still more preferably 10 wt % or less, and still even more preferably 5 wt % or less in consideration of forming an undercoat layer with a desired coating weight and film thickness. The solid content concentration may have any lower limit, but the lower limit is preferably 0.1 wt % or more, more preferably 0.5 wt % or more, and still more preferably 1 wt % or more from a practical viewpoint.

The solid content is the total amount of the components, other than the solvent, included in the dispersion.

The dispersion of the present invention can be applied to and formed into a film on a suitable substrate of PET, glass, ITO, or the like with a suitable method such as a spin coating, dipping, flow coating, inkjet, spraying, bar coating, gravure coating, slit coating, roll coating, transfer printing, brush coating, blade coating, or air knife coating method.

The obtained thin film can be suitably used in conductive materials that make use of the metallic qualities of CNTs, such as antistatic films and transparent electrodes, and in elements that make use of the semiconducting qualities of CNTs, such as photoelectric conversion elements, thermoelectric conversion elements, and electroluminescence elements.

### EXAMPLES

Hereinafter, the present invention is more specifically described with reference to Examples and Comparative Examples, but the present invention is not limited to the following Examples. The devices used are as follows.

### (1) Probe-Type Ultrasonicator

UIP1000 manufactured by Hielscher Ultrasonics GmbH

### (2) Particle Size Distribution Meter

Laser diffraction/scattering particle size distribution analyzer LA-960 manufactured by HORIBA, Ltd.

### <Measurement Conditions>

Measurement cell: flow cell
Refractive index of measurement solvent: 1.333-0.000 i (ion-exchanged water)
Refractive index of solute: 1.920-0.522 i (carbon)
Irradiation with ultrasonic wave: none

### (3) Thermostatic Bath

DDRV422C VACUUM DRYING OVEN manufactured by ADVANTEC

### (4) Size Exclusion Chromatography (SEC) (Estimation of Weight Average Molecular Weight)

High performance liquid chromatograph Prominence manufactured by SHIMADZU CORPORATION
Eluent: 5 mM sodium tetraborate decahydrate (pH 9.3)
Column: TSK gel α6000 manufactured by Tosoh Corporation+TSK gel α4000 manufactured by Tosoh Corporation
Column temperature: 40° C.
Detector: UV (210 nm)
Flow rate: 0.5 mL/min
Sample concentration: 0.1% (10 μL injection)

### [1] Synthesis of P1 Polymer

### [Synthesis Example 1] Synthesis of Compound A

In a 200 mL four-necked flask, 4.48 g (52.0 mmol) of methacrylic acid (manufactured by JUNSEI CHEMICAL CO., LTD.), 10.0 g (63.6 mmol) of dimethylaminoethyl methacrylate (manufactured by Tokyo Chemical Industry Co., Ltd.), and 0.012 g (0.038 mmol) of VE-073 (manufactured by FUJIFILM Wako Pure Chemical Corporation) as an initiator were dissolved in 82.12 g of ethanol (manufactured by JUNSEI CHEMICAL CO., LTD.). The inside of the system was replaced with a nitrogen gas, then the internal temperature was raised to 80° C., and the solution was heated and stirred for 5 hours. The reaction solution was cooled and added dropwise to 500 g of hexane, and the generated sediment was filtered off. The obtained residue was dispersed in 100 g of ethanol again and added dropwise to 500 g of hexane (manufactured by JUNSEI CHEMICAL CO., LTD.). The generated sediment was filtered off, and then the obtained residue was dried under reduced pressure at 60° C. for 6 hours to obtain a white compound A (yield amount: 6.53 g, yield rate: 45.0%). The Mw of the obtained P1 polymer was 1.45×10⁵ (as a sodium polystyrene sulfonate-equivalent value).

### [2] Preparation of Carbon Nanotube Dispersion

### [Preparation Example 1] Preparation of Dispersion A

A mixture was prepared of 0.5 g (100 parts by weight) of FloTube 6121 (multilayer CNT manufactured by Jiangsu Cnano Technology Co., Ltd.) as a CNT, 5.0 g (100 parts by weight) of WS-300 (manufactured by NIPPON SHOKUBAI CO., LTD., solid content concentration: 10.0 wt %) as an aqueous solution containing an oxazoline polymer, 37.15 g of pure water, and 7.35 g of 2-propanol (manufactured by JUNSEI CHEMICAL CO., LTD., special grade). The obtained mixture was subjected to ultrasonic treatment for 30 minutes using a probe-type ultrasonicator to prepare a dispersion A in which the CNT was uniformly dispersed.

### Example 1

A mixture was prepared of 200 parts by weight of the compound A, pure water, 2-propanol (manufactured by JUNSEI CHEMICAL CO., LTD., special grade), and 200 parts by weight of ammonia (666.67 parts by weight of a 30 wt % aqueous ammonia). The mixed solution was added to the dispersion A to prepare a dispersion 1 having a solid content concentration of 1 wt %. At this time, the solvents were finally mixed at a mixing ratio of pure water:2-propanol=92:8 (weight ratio). The dispersion 1 was a black ink in which the CNT was uniformly dispersed.

### Example 2

A mixture was prepared of 200 parts by weight of the compound A, pure water, 2-propanol (manufactured by JUNSEI CHEMICAL CO., LTD., special grade), and 10 parts by weight of ammonia (33.33 parts by weight of a 30 wt % aqueous ammonia). The mixed solution was added to the dispersion A to prepare a dispersion composition B having a solid content concentration of 1 wt %. At this time, the solvents were finally mixed at a mixing ratio of pure water:2-propanol=92:8 (weight ratio). The dispersion 2 was a black ink in which the CNT was uniformly dispersed.

### Comparative Example 1

The dispersion A prepared in Preparation Example 1 was used as a dispersion C1 as it was.

### Comparative Example 2

In the dispersion A, 76 parts by weight of Aron A-30, pure water, and 2-propanol (manufactured by JUNSEI CHEMICAL CO., LTD., special grade) were mixed to prepare a dispersion C2 having a solid content concentration of 1.38 wt %. At this time, the solvents were finally mixed at a mixing ratio of pure water:2-propanol=85:15 (weight ratio). The dispersion C2 was a black ink in which the CNT was uniformly dispersed.

### Comparative Example 3

In the dispersion A, 76 parts by weight of Aron A-30, pure water, and 2-propanol (manufactured by JUNSEI CHEMICAL CO., LTD., special grade) were mixed to prepare a dispersion C3 having a solid content concentration of 1.00 wt %. At this time, the solvents were finally mixed at a mixing ratio of pure water:2-propanol=85:15 (weight ratio). The dispersion C3 was a black ink in which the CNT was uniformly dispersed.

Table 1 summarizes the compositions of the dispersions 1, 2, and C1 to C3.

The particle size distribution (median diameter d₅₀ and d₉₀) of the obtained dispersion was measured using a particle size distribution meter immediately after the preparation (before storage) and after the storage for 1 day under heating conditions. Table 1 shows the results.

To heat the dispersion, the dispersion was put in a 50 ml polyethylene bottle and allowed to stand in a thermostatic bath heated to 50° C. for 1 day. Thereafter, the dispersion was taken out from the thermostatic bath, cooled to room temperature, and then used for measurement of the particle size distribution. In the present invention, the term “room temperature” means 23° C.±5° C., and the room temperature is preferably 23° C.

TABLE 1

| | | | | | Comparative | Comparative | Comparative |
|---|---|---|---|---|---|---|---|
| | | | Example 1 | Example 2 | Example 1 | Example 2 | Example 3 |
| | | | Dispersion 1 | Dispersion 2 | Dispersion C1 | Dispersion C2 | Dispersion C3 |
| Composition | FloTube 6121 | | 100 | 100 | 100 | 100 | 100 |
| (parts by | WS-300 | | 100 | 100 | 100 | 100 | 100 |
| weight) | Compound A | | 200 | 200 | 0 | 0 | 0 |
| | Aron A-30 | | 0 | 0 | 0 | 76 | 76 |
| | Aqueous | | 200 | 10 | 0 | 0 | 0 |
| | ammonia | | | | | | |
| Solid content | | | 1.00 | 1.00 | 2.00 | 1.38 | 1.00 |
| concentration (wt %) | | | | | | | |
| Particle size | 50° C. | d₅₀ | 1.4 | 1.4 | 9.9 | 1.4 | 1.4 |
| distribution | Before | d₅₀ | 2.5 | 2.5 | 14.7 | 2.6 | 2.6 |
| (μm) | storage | | | | | | |
| | 50° C. | d₅₀ | 1.4 | 1.4 | Unmeasurable | 5.2 | 3.4 |
| | After | | | | | | |
| | storage | d₅₀ | 2.4 | 2.4 | Unmeasurable | 7.4 | 5.1 |

From the results shown in Table 1, the following was confirmed.

In the dispersions of Examples 1 and 2, it was confirmed that the particle size of the CNT was small immediately after the preparation and good dispersibility was ensured. After the storage, the particle size of the CNT was almost not different from the particle size before the storage, and thus it was confirmed that the dispersion state of the CNT was not changed and a good dispersion state was maintained.

In the dispersion of Comparative Example 1, the particle size of the CNT immediately after the preparation was larger than those in Examples, and thus it was confirmed that the dispersibility of the CNT was inferior to that in Examples. Furthermore, after the storage, the CNT was aggregated and lost the fluidity, and the particle size distribution became unmeasurable. From this result, it was confirmed that the dispersion state of the CNT was more likely to change in the dispersion of Comparative Example 1 than in the dispersions of Examples, and that the dispersion of Comparative Example 1 was inferior in the effect of suppressing aggregation to the dispersions in Examples.

In the dispersions of Comparative Examples 2 and 3, the particle size of the CNT was small immediately after the preparation, and good dispersibility was obtained. However, it was confirmed that after the storage, the particle size of the CNT was increased and the CNT was aggregated. From these results, it was confirmed that the dispersion state of the CNT was more likely to change in the dispersions of Comparative Examples 2 and 3 than in the dispersions of Examples, and that the dispersions of Comparative Examples 2 and 3 were inferior in the effect of suppressing aggregation to the dispersions in Examples.

1. A carbon nanotube dispersion comprising: a carbon nanotube; a dispersant; a solvent; and a polymer having a pendant chain having a partial structure of formula (P1) described below: 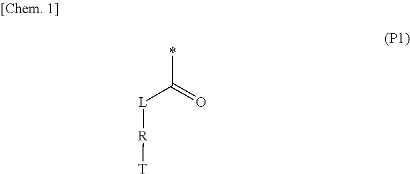
wherein L represents —O— or —NH—, R represents an alkylene group having 1 to 20 carbon atoms, T represents a substituted or unsubstituted amino group, a nitrogen-containing heteroaryl group having 2 to 20 carbon atoms, or a nitrogen-containing aliphatic heterocyclic group having 2 to 20 carbon atoms, and * represents a bonding site.

2. The carbon nanotube dispersion of claim 1, wherein the partial structure of formula (P1) has any one of formulas (P1-1) to (P1-3) described below: 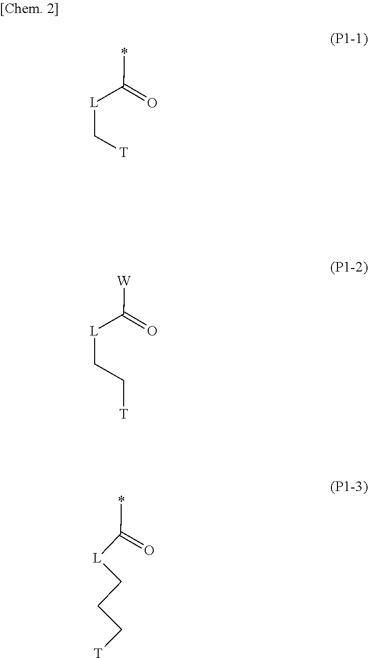
wherein L, T, and * are as described above.

3. The carbon nanotube dispersion of claim 2, wherein the partial structure of formula (P1) has any one of formulas (P2-1) to (P2-3) described below: 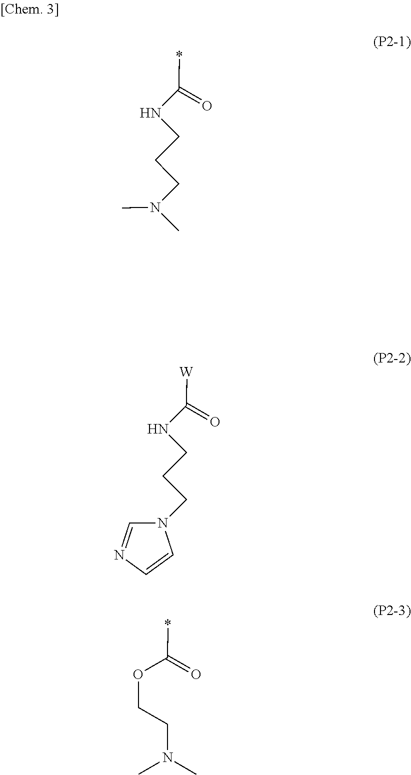
wherein * is as described above.

4. The carbon nanotube dispersion of claim 1, wherein the polymer includes repeating units of formula (C1-1) or (C1-2) described below: 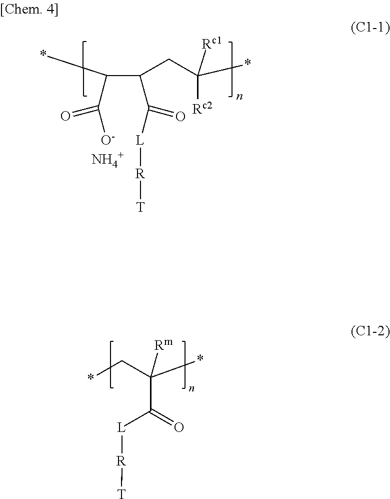
wherein R^{c1} and R^{c2} each independently represent a hydrogen atom or an alkyl group having 1 to 20 carbon atoms, R^{m} represents a hydrogen atom or a methyl group, n represents a natural number, and L, R, T, and * are as described above.

5. The carbon nanotube dispersion of claim 1, wherein the solvent includes one or more selected from the group consisting of water and hydrophilic solvents.

6. The carbon nanotube dispersion of claim 1, wherein the dispersant includes a pendant oxazoline group-containing polymer or a triarylamine-based highly branched polymer.

7. The carbon nanotube dispersion of claim 1, further comprising a crosslinking agent.
